(19) United States
(12) Patent Application Publication
(10) Pub. No.: US 2009/0258799 A1
(43) Pub. Date: Oct. 15, 2009

(54) WELLBORE FLUIDS POSSESSING IMPROVED RHEOLOGICAL AND ANTI-SAG PROPERTIES

(75) Inventors: Mike Hodder, Aberdeen (GB); Andy Popplestone, Aberdeen (GB)

Correspondence Address: OSHA LIANG/MI, TWO HOUSTON CENTER, 909 FANNIN STREET, SUITE 3500, HOUSTON, TX, 77010, US

(73) Assignee: M-I LLC, Houston, TX (US)

(21) Appl. No.: 12/100,232

(22) Filed: Apr. 9, 2008

(51) Int. Cl. C09K 8/02

(52) U.S. Cl. 507/140; 507/100

(57) ABSTRACT

A wellbore fluid that includes a base fluid; a weighting agent having a d₉₀ greater than 30 microns; and a micronized weighting agent having a d₉₀ less than 25 microns, the micronized weighting agent comprising less than 30 percent by volume of the total weighting agents is disclosed herein.

### BACKGROUND OF INVENTION

1. Field of the Invention

Embodiments disclosed herein relate generally to wellbore fluids. In particular, embodiments disclosed herein relate to wellbore fluids used in high pressure, high temperature conditions.

2. Background Art

When drilling or completing wells in earth formations, various fluids typically are used in the well for a variety of reasons. Common uses for well fluids include: lubrication and cooling of drill bit cutting surfaces while drilling generally or drilling-in (i.e., drilling in a targeted petroliferous formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, transmitting hydraulic horsepower to the drill bit, fluid used for emplacing a packer, abandoning the well or preparing the well for abandonment, and otherwise treating the well or the formation.

In general, drilling fluids should be pumpable under pressure down through strings of drilling pipe, then through and around the drilling bit head deep in the earth, and then returned back to the earth surface through an annulus between the outside of the drill stem and the hole wall or casing. Beyond providing drilling lubrication and efficiency, and retarding wear, drilling fluids should suspend and transport solid particles to the surface for screening out and disposal. In addition, the fluids should be capable of suspending additive weighting agents (to increase specific gravity of the mud), generally finely ground barites (barium sulfate ore), and transport clay and other substances capable of adhering to and coating the borehole surface.

Drilling fluids are generally characterized as thixotropic fluid systems. That is, they exhibit low viscosity when sheared, such as when in circulation (as occurs during pumping or contact with the moving drilling bit). However, when the shearing action is halted, the fluid should be capable of suspending the solids it contains to prevent gravity separation. In addition, when the drilling fluid is under shear conditions and a free-flowing near-liquid, it must retain a sufficiently high enough viscosity to carry all unwanted particulate matter from the bottom of the well bore to the surface. The drilling fluid formulation should also allow the cuttings and other unwanted particulate material to be removed or otherwise settle out from the liquid fraction.

There is an increasing need for drilling fluids having the rheological profiles that enable these wells to be drilled more easily. Drilling fluids having tailored rheological properties ensure that cuttings are removed from the wellbore as efficiently and effectively as possible to avoid the formation of cuttings beds in the well which can cause the drill string to become stuck, among other issues. There is also the need from a drilling fluid hydraulics perspective (equivalent circulating density) to reduce the pressures required to circulate the fluid, this helps to avoid exposing the formation to excessive forces that can fracture the formation causing the fluid, and possibly the well, to be lost. In addition, an enhanced profile is necessary to prevent settlement or sag of the weighting agent in the fluid, if this occurs it can lead to an uneven density profile within the circulating fluid system which can result in well control (gas/fluid influx) and wellbore stability problems (caving/fractures).

To obtain the fluid characteristics required to meet these challenges, the fluid must be easy to pump so it requires the minimum amount of pressure to force it through restrictions in the circulating fluid system, such as bit nozzles or down-hole tools. Or in other words, the fluid must have the lowest possible viscosity under high shear conditions. Conversely, in zones of the well where the area for fluid flow is large and the velocity of the fluid is slow or where there are low shear conditions, the viscosity of the fluid needs to be as high as possible in order to suspend and transport the drilled cuttings. This also applies to the periods when the fluid is left static in the hole, where both cuttings and weighting materials need to be kept suspended to prevent settlement. However, it should also be noted that the viscosity of the fluid should not continue to increase under static conditions to unacceptable levels. Otherwise when the fluid needs to be circulated again this can lead to excessive pressures that can fracture the formation or alternatively it can lead to lost time if the force required to regain a fully circulating fluid system is beyond the limits of the pumps.

Wellbore fluids must also contribute to the stability of the well bore, and control the flow of gas, oil or water from the pores of the formation in order to prevent, for example, the flow or blow out of formation fluids or the collapse of pressured earth formations. The column of fluid in the hole exerts a hydrostatic pressure proportional to the depth of the hole and the density of the fluid. High-pressure formations may require a fluid with a specific gravity as high as 3.0.

A variety of materials are presently used to increase the density of wellbore fluids. These include dissolved salts such as sodium chloride, calcium chloride and calcium bromide. Alternatively, powdered minerals such as barite, calcite and hematite are added to a fluid to form a suspension of increased density. The use of finely divided metal, such as iron, as a weight material in a drilling fluid wherein the weight material includes iron/steel ball-shaped particles having a diameter less than 250 microns and preferentially between 15 and 75 microns has also been described. The use of finely powdered calcium or iron carbonate has also been proposed; however, the plastic viscosity of such fluids rapidly increases as the particle size decreases, limiting the utility of these materials.

One requirement of these wellbore fluid additives is that they form a stable suspension and do not readily settle out. A second requirement is that the suspension exhibit a low viscosity in order to facilitate pumping and to minimize the generation of high pressures. Finally, the wellbore fluid slurry should also exhibit low fluid loss.

Conventional weighting agents such as powdered barite exhibit an average particle diameter (d₅₀) in the range of 10-30 microns. To adequately suspend these materials requires the addition of a gellant such as bentonite for water-based fluids, or organically modified bentonite for oil-based fluids. A soluble polymer viscosifier such as xanthan gum may be also added to slow the rate of the sedimentation of the weighting agent. However, as more gellant is added to increase the suspension stability, the fluid viscosity (plastic viscosity and/or yield point) increases undesirably resulting in reduced pumpability. This is also the case if a viscosifier is used to maintain a desirable level of solids suspension.

The sedimentation (or “sag”) of particulate weighting agents becomes more critical in wellbores drilled at high angles from the vertical, in that a sag of, for example, one inch (2.54 cm) can result in a continuous column of reduced density fluid along the upper portion of the wellbore wall. Such high angle wells are frequently drilled over large distances in order to access, for example, remote portions of an oil reservoir. In such instances it is important to minimize a drilling fluid's plastic viscosity in order to reduce the pressure losses over the borehole length. At the same time a high density also should be maintained to prevent a blow out. Further, as noted above with particulate weighting materials the issues of sag become increasingly important to avoid differential sticking or the settling out of the particulate weighting agents on the low side of the wellbore.

Being able to formulate a drilling fluid having a high density and a low plastic viscosity is also important in deep high pressure wells where high-density wellbore fluids are required. High viscosities can result in an increase in pressure at the bottom of the hole under pumping conditions. This increase in “Equivalent Circulating Density” (ECD) can result in opening fractures in the formation, and serious losses of the wellbore fluid into the fractured formation. Again the stability of the suspension is important in order to maintain the hydrostatic head to avoid a blow out. The goal of high-density fluids with low viscosity plus minimal sag of weighting material continues to be a challenge.

According, there is a continuing need for methods that increase fluid density while simultaneously providing improved suspension stability and minimizing both fluid loss and increases in viscosity.

### SUMMARY OF INVENTION

In one aspect, embodiments disclosed herein relate to a wellbore fluid that includes a base fluid; a weighting agent having a d₉₀ greater than 30 microns; and a micronized weighting agent having a d₉₀ less than 25 microns, the micronized weighting agent comprising less than 30 percent by volume of the total weighting agents.

In another aspect, embodiments disclosed herein relate to a wellbore fluid that includes a base fluid; a weighting agent having a d₅₀ greater than 10 microns; and a micronized weighting agent having a d₅₀ less than 2 microns, the micronized weighting agent comprising less than 30 percent by volume of the total weighting agents.

In another aspect, embodiments disclosed herein relate to a wellbore fluid that includes an oleaginous fluid as a continuous phase; a non-oleaginous fluid as a discontinuous phase; a weighting agent having a d₉₀ greater than 30 microns; and a micronized weighting agent having a d₉₀ less than 5 microns, the micronized weighting agent comprising less than 30 percent by volume of the total weighting agents; wherein the wellbore fluid comprises a solids volume fraction of less than 50 percent.

In yet another aspect, embodiments disclosed herein relate to a method of increasing the density of a fluid phase of a drilling fluid that includes adding to the fluid phase of the drilling fluid at least two weighting agents for increasing the density of the drilling fluid, wherein the at least two weighting agents comprise: a weighting agent having a d₉₀ greater than 30 microns; and a micronized weighting agent having a d₉₀ less than 5 microns, the micronized weighting agent comprising less than 30 percent by volume of the total weighting agents.

In yet another aspect, embodiments disclosed herein relate to a method of drilling a subterranean well that includes adding at least two weighting agents to a base fluid to form a drilling fluid, the at least two weighting agents comprising: a weighting agent having a d₉₀ greater than 30 microns; and a micronized weighting agent having a d₉₀ less than 5 microns, the micronized weighting agent comprising less than 30 percent by volume of the total weighting agents; and drilling the well using the drilling fluid.

Other aspects and advantages of the invention will be apparent from the following description and the appended claims.

### BRIEF DESCRIPTION OF DRAWINGS

FIG. 1 is a graph showing the effect of the addition of micronized weighting agents on the viscosity of a wellbore fluid in accordance with embodiments of the present disclosure.

FIG. 2 is a graph showing the effect of the addition of micronized weighting agents on free oil in accordance with embodiments of the present disclosure.

### DETAILED DESCRIPTION

In one aspect, embodiments disclosed herein relate to wellbore fluids used in high pressure, high temperature downhole conditions. As described above, deep high pressure wells must be drilled using high density wellbore fluids to maintain well stability and prevent blowouts. However, increasing the density of a fluid by increasing the solids content typically results in an increased viscosity, which thus increases the pressures required to circulate the fluid. Such increases in circulation requirements present risks of excessive forces that can fracture the formation. Thus, while such fluid design constrictions may appear to be contradictory, the fluids of the present disclosure may allow for use of a high density fluid that may also possess improved rheological properties (leading to a reduced ECD) and/or reduced sag. In particular, embodiments of the present disclosure relate to the use of wellbore fluids which contain more than one particulate weighting agent, each having distinct size range, wherein at least one of the particulate weighting agents is micronized, as discussed below.

The incorporation of the micronized weighting agent with a larger weighting agent in the wellbore fluids of the present disclosure may allow for the micronized particles to fill the spaces between the larger particles of weighting agent. Without being bound by any particular theory, the present inventors theorize that such filling of voids with micronized particles displaces the base fluid from those voids now occupied by the micronized particles, and thus lowers the plastic viscosity of the fluid. To achieve this effect, the particle size ranges and amounts of the distinct particulate weighting agent may be carefully selected. One of ordinary skill in the art would appreciate that for ease in comparing two distinct particulate weighting agents, particle size distribution percentiles may be used (i.e., d₅₀ and d₉₀, where d₅₀=the grain size at which 50% of sample is finer and d₉₀ is the grain size at which 90% of sample is finer). Thus, embodiments of the present disclosure relate to wellbore fluids that are formed by combining weighting agents portions that have distinct d₅₀ and d₉₀ values.

The weighting agents used in some embodiments disclosed herein may include a variety of compounds well known to one of skill in the art. In a particular embodiment, the weighting agent may be selected from one or more of the materials including, for example, barium sulphate (barite), calcium carbonate (calcite), dolomite, haussmanite (or other forms of manganese tetraoxide), ilmenite, hematite or other iron ores, olivine, siderite, manganese oxide, and strontium sulphate. One having ordinary skill in the art would recognize that selection of a particular material may depend largely on the density of the material, as typically, the lowest wellbore fluid viscosity at any particular density is obtained by using the highest density particles. However, other considerations may influence the choice of product such as cost, local availability, the power required for grinding, and whether the residual solids or filter cake may be readily removed from the well.

In one embodiment, the micronized weighting agent may have a d₉₀ less than 25 microns, and less than 10 or 8 microns in other embodiments. In a particular embodiment, the micronized weighting agent may have a d₉₀ ranging from 1 to 25 microns and a d₅₀ ranging from 0.5 to 10 microns. In another embodiment, the micronized weighting agent includes particles having a d₉₀ ranging from 2 to 8 microns and a d₅₀ ranging from 0.5 to 5 microns.

As described above, the micronized weighting agent particles are smaller particles that may fit within the spaces between larger weighting agent particles. The larger weighting agent materials may have a d₉₀ greater than 30 microns in some embodiments, and greater than 45 or 70 microns in yet other embodiments. In a particular embodiment, the larger weighting agent may include particles having a d₉₀ ranging from 30 to 80 microns and a d₅₀ ranging from 10 to 30 microns. In another embodiment, the larger weighting agent may include particles having a d₉₀ ranging from 30 to 40 microns and a d₅₀ ranging from 10 to 16 microns. In yet another embodiment, the larger weighting agent may include particles having a d₉₀ ranging from 40 to 60 microns and a d₅₀ ranging from 12 to 25 microns. In yet another embodiment, the larger weighting agent may include particles having a d₉₀ ranging from 60 to 80 microns and a d₅₀ ranging from 16 to 30 microns.

In a particular embodiment, an overall bimodal distribution of sized weightings may be present in the formed fluids. However, in other embodiments, a tri- or other multimodal distribution may be desired. When such multimodal distribution is desirable, the larger weighting agent may actually include multiple particle size ranges/distributions. For example, it may be desirable to combine micronized weighting agents with a first weighting agent having a d₉₀ ranging from 30 to 40 microns and a second weighting agent having a d₉₀ ranging from 60 to 80 microns. In such embodiments, any of the particle size distribution percentile values described above may be used to form an overall multimodal distribution.

Further, while it is clear by the use of multiple particle size groups of weighting agent renders a total particle size distribution other than monomodal, one of ordinary skill in the art would recognize that, depending on the sizing technique, each particle size “grouping” of weighting agent may have a particle size distribution other than a monomodal distribution. That is, each weighting agent group may have a particle size distribution that, in various embodiments, may be monomodal, which may or may not be Gaussian, bimodal, or polymodal.

To formulate a fluid suitable for high pressure wellbore, sufficient amounts of weighting agents may be added to result in a wellbore fluid density greater than 15 ppg. However, in other embodiments, the fluid formulation density may range from 15-20 ppg. Such solids content may result in a solids volume fraction of less than about 50 percent. In various other embodiments, the solids volume fraction may range from about 35 to 45 percent, and may preferably be about 40 percent. One of ordinary skill in the art would appreciate that depending on the desired density, the solids content may vary; however, as solids content approach levels significantly greater than 50 percent, “cementing” up of the wellbore fluid will likely result.

With such solids contents, an amount of micronized weighting agent as compared to larger weighting agents may be selected. In a particular embodiment, an optimum amount of micronized weighting agent may be less than 30 percent by volume of the total weighting agents, which is less than the predicted ideal value according the packing volume fraction theory. In another embodiment, the optimum amount may be less than 20 percent, or range from 5 to 25 percent by volume or 10 to 20 percent by volume of the total weighting agents, in various other embodiments.

Micronized Weighting Agent

As discussed above, the fluids of the present disclosure may include micronized weighting agents. In some embodiments, the micronized weighting agents may be uncoated, or alternatively, coated with a dispersant. For example, fluids used in some embodiments disclosed herein may include dispersant coated micronized weighting agents. The coated weighting agents may be formed by either a dry coating process or a wet coating process. Weighting agents suitable for use in other embodiments disclosed herein may include those disclosed in U.S. Patent Application Publication Nos. 20040127366, 20050101493, 20060188651, U.S. Pat. Nos. 6,586,372 and 7,176,165, and U.S. Provisional Application Ser. No. 60/825,156, each of which is hereby incorporated by reference.

The use of micronized weighting agents has been disclosed in U.S. Patent Application Publication No. 20050277553 assigned to the assignee of the current application, and herein incorporated by reference. The micronized particles having such size distributions may be obtained by several means. For example, sized particles, such as a suitable barite product having similar particle size distributions as disclosed herein, may be commercially purchased. A coarser ground suitable material may be obtained, and the material may be further ground by any known technique to the desired particle size. Such techniques include jet-milling, high performance dry milling techniques, or any other technique that is known in the art generally for milling powdered products. In one embodiment, appropriately sized particles of barite may be selectively removed from a product stream of a conventional barite grinding plant, which may include selectively removing the fines from a conventional API-grade barite grinding operation. Fines are often considered a by-product of the grinding process, and conventionally these materials are blended with courser materials to achieve API-grade barite. However, in accordance with the present disclosure, these by-product fines may be further processed via an air classifier to achieve the particle size distributions disclosed herein. In yet another embodiment, the micronized weighting agents may be formed by chemical precipitation. Such precipitated products may be used alone or in combination with mechanically milled products.

In some embodiments, the micronized weighting agents may include solid colloidal particles having a deflocculating agent or dispersant coated onto the surface of the particle. Further, one of ordinary skill would appreciate that the term “colloidal” refers to a suspension of the particles, and does not impart any specific size limitation. Rather, the size of the micronized weighting agents of the present disclosure may vary in range and are only limited by the claims of the present application. The micronized particle size generates high density suspensions or slurries that show a reduced tendency to sediment or sag, while the dispersant on the surface of the particle controls the inter-particle interactions resulting in lower rheological profiles. Thus, the combination of high density, fine particle size, and control of colloidal interactions by surface coating the particles with a dispersant reconciles the objectives of high density, lower viscosity and minimal sag.

In some embodiments, a dispersant may be coated onto the particulate weighting additive during the commination (grinding) process. That is to say, coarse weighting additive is ground in the presence of a relatively high concentration of dispersant such that the newly formed surfaces of the fine particles are exposed to and thus coated by the dispersant. It is speculated that this allows the dispersant to find an acceptable conformation on the particle surface thus coating the surface. Alternatively, it is speculated that because a relatively higher concentration of dispersant is in the grinding fluid, as opposed to that in a drilling fluid, the dispersant is more likely to be absorbed (either physically or chemically) to the particle surface. As that term is used in herein, “coating of the surface” is intended to mean that a sufficient number of dispersant molecules are absorbed (physically or chemically) or otherwise closely associated with the surface of the particles so that the fine particles of material do not cause the rapid rise in viscosity observed in the prior art. By using such a definition, one of skill in the art should understand and appreciate that the dispersant molecules may not actually be fully covering the particle surface and that quantification of the number of molecules is very difficult. Therefore, by necessity, reliance is made on a results oriented definition. As a result of the process, one can control the colloidal interactions of the fine particles by coating the particle with dispersants prior to addition to the drilling fluid. By doing so, it is possible to systematically control the rheological properties of fluids containing in the additive as well as the tolerance to contaminants in the fluid in addition to enhancing the fluid loss (filtration) properties of the fluid.

In some embodiments, the weighting agents include dispersed solid colloidal particles with a weight average particle diameter (d₅₀) of less than 10 microns that are coated with a polymeric deflocculating agent or dispersing agent. In other embodiments, the weighting agents include dispersed solid colloidal particles with a weight average particle diameter (d₅₀) of less than 8 microns that are coated with a polymeric deflocculating agent or dispersing agent; less than 6 microns in other embodiments; less than 4 microns in other embodiments; and less than 2 microns in yet other embodiments. The fine particle size will generate suspensions or slurries that will show a reduced tendency to sediment or sag, and the polymeric dispersing agent on the surface of the particle may control the inter-particle interactions and thus will produce lower rheological profiles. It is the combination of fine particle size and control of colloidal interactions that may reconcile the two objectives of lower viscosity and minimal sag. Additionally, the presence of the dispersant in the commination process yields discrete particles which can form a more efficiently packed filter cake and so advantageously reduce filtration rates.

Coating of the micronized weighting agent with the dispersant may also be performed in a dry blending process such that the process is substantially free of solvent. The process includes blending the weighting agent and a dispersant at a desired ratio to form a blended material. In one embodiment, the weighting agent may be un-sized initially and rely on the blending process to grind the particles into the desired size range as disclosed above. Alternatively, the process may begin with sized weighting agents. The blended material may then be fed to a heat exchange system, such as a thermal desorption system. The mixture may be forwarded through the heat exchanger using a mixer, such as a screw conveyor. Upon cooling, the polymer may remain associated with the weighting agent. The polymer/weighting agent mixture may then be separated into polymer coated weighting agent, unassociated polymer, and any agglomerates that may have formed. The unassociated polymer may optionally be recycled to the beginning of the process, if desired. In another embodiment, the dry blending process alone may serve to coat the weighting agent without heating.

Alternatively, a sized weighting agent may be coated by thermal adsorption as described above, in the absence of a dry blending process. In this embodiment, a process for making a coated substrate may include heating a sized weighting agent to a temperature sufficient to react monomeric dispersant onto the weighting agent to form a polymer coated sized weighting agent and recovering the polymer coated weighting agent. In another embodiment, one may use a catalyzed process to form the polymer in the presence of the sized weighting agent. In yet another embodiment, the polymer may be preformed and may be thermally adsorbed onto the sized weighting agent.

In some embodiments, the micronized weighting agent may be formed of particles that are composed of a material of specific gravity of at least 2.3; at least 2.4 in other embodiments; at least 2.5 in other embodiments; at least 2.6 in other embodiments; and at least 2.68 in yet other embodiments. For example, a weighting agent formed of particles having a specific gravity of at least 2.68 may allow wellbore fluids to be formulated to meet most density requirements yet have a particulate volume fraction low enough for the fluid to be pumpable.

As mentioned above, embodiments of the micronized weighting agent may include a deflocculating agent or a dispersant. In one embodiment, the dispersant may be selected from carboxylic acids of molecular weight of at least 150 Daltons, such as oleic acid and polybasic fatty acids, alkylbenzene sulphonic acids, alkane sulphonic acids, linear alpha-olefin sulphonic acids, phospholipids such as lecithin, including salts thereof and including mixtures thereof. Synthetic polymers may also be used, such as HYPERMER OM-1 (Imperial Chemical Industries, PLC, London, United Kingdom) or polyacrylate esters, for example. Such polyacrylate esters may include polymers of stearyl methacrylate and/or butylacrylate. In another embodiment, the corresponding acids methacrylic acid and/or acrylic acid may be used. One skilled in the art would recognize that other acrylate or other unsaturated carboxylic acid monomers (or esters thereof) may be used to achieve substantially the same results as disclosed herein.

When a dispersant coated micronized weighting agent is to be used in water-based fluids, a water soluble polymer of molecular weight of at least 2000 Daltons may be used in a particular embodiment. Examples of such water soluble polymers may include a homopolymer or copolymer of any monomer selected from acrylic acid, itaconic acid, maleic acid or anhydride, hydroxypropyl acrylate vinylsulphonic acid, acrylamido 2-propane sulphonic acid, acrylamide, styrene sulphonic acid, acrylic phosphate esters, methyl vinyl ether and vinyl acetate or salts thereof.

The polymeric dispersant may have an average molecular weight from about 10,000 Daltons to about 300,000 Daltons in one embodiment, from about 17,000 Daltons to about 40,000 Daltons in another embodiment, and from about 200,000-300,000 Daltons in yet another embodiment. One of ordinary skill in the art would recognize that when the dispersant is added to the weighting agent during a grinding process, intermediate molecular weight polymers (10,000-300,000 Daltons) may be used.

Further, it is specifically within the scope of the embodiments disclosed herein that the polymeric dispersant be polymerized prior to or simultaneously with the wet or dry blending processes disclosed herein. Such polymerizations may involve, for example, thermal polymerization, catalyzed polymerization, initiated polymerization or combinations thereof.

Given the particulate nature of the micronized and dispersant coated micronized weighting agents disclosed herein, one of skill in the art should appreciate that additional components may be mixed with the weighting agent to modify various macroscopic properties. For example, anti-caking agents, lubricating agents, and agents used to mitigate moisture build-up may be included. Alternatively, solid materials that enhance lubricity or help control fluid loss may be added to the weighting agents and drilling fluid disclosed herein. In one illustrative example, finely powdered natural graphite, petroleum coke, graphitized carbon, or mixtures of these are added to enhance lubricity, rate of penetration, and fluid loss as well as other properties of the drilling fluid. Another illustrative embodiment utilizes finely ground polymer materials to impart various characteristics to the drilling fluid. In instances where such materials are added, it is important to note that the volume of added material should not have a substantial adverse impact on the properties and performance of the drilling fluids. In one illustrative embodiment, polymeric fluid loss materials comprising less than 5 percent by weight are added to enhance the properties of the drilling fluid. Alternatively, less than 5 percent by weight of suitably sized graphite and petroleum coke are added to enhance the lubricity and fluid loss properties of the fluid. Finally, in another illustrative embodiment, less than 5 percent by weight of a conventional anti-caking agent is added to assist in the bulk storage of the weighting materials.

The particulate materials as described herein (i.e., the coated and/or uncoated micronized weighting agents) may be added to a drilling fluid as a weighting agent in a dry form or concentrated as slurry in either an aqueous medium or as an organic liquid. As is known, an organic liquid should have the necessary environmental characteristics required for additives to oil-based drilling fluids. With this in mind, the oleaginous fluid may have a kinematic viscosity of less than 10 centistokes (10 mm²/s) at 40° C. and, for safety reasons, a flash point of greater than 60° C. Suitable oleaginous liquids are, for example, diesel oil, mineral or white oils, n-alkanes or synthetic oils such as alpha-olefin oils, ester oils, mixtures of these fluids, as well as other similar fluids known to one of skill in the art of drilling or other wellbore fluid formulation. In one embodiment, the desired particle size distribution is achieved via wet milling of the courser materials in the desired carrier fluid.

Base Fluid

The particles described above may be used in any wellbore fluid such as drilling, completion, packing, work-over (repairing), stimulation, well killing, spacer fluids, and other uses of high density fluids, such as in a dense media separating fluid or in a ship's or other vehicle's ballast fluid. Such alternative uses, as well as other uses, of the present fluid should be apparent to one of skill in the art given the present disclosure. In accordance with one embodiment, the weighting agents may be used in a wellbore fluid formulation. The wellbore fluid may be a water-based fluid, a direct emulsion, an invert emulsion, or an oil-based fluid.

Water-based wellbore fluids may have an aqueous fluid as the base liquid and a precipitated weighting agent (coated or uncoated). Water-based wellbore fluids may have an aqueous fluid as the base fluid and a precipitated weighting agent. The aqueous fluid may include at least one of fresh water, sea water, brine, mixtures of water and water-soluble organic compounds and mixtures thereof. For example, the aqueous fluid may be formulated with mixtures of desired salts in fresh water. Such salts may include, but are not limited to alkali metal chlorides, hydroxides, or carboxylates, for example. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, sulfur, aluminum, magnesium, potassium, strontium, silicon, lithium, and phosphorus salts of chlorides, bromides, carbonates, iodides, chlorates, bromates, formates, nitrates, oxides, and fluorides. Salts that may be incorporated in a brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the drilling fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

In a particular embodiment, the weighting agents disclosed herein may be include in a base fluid, which may be an oil-based fluid and/or an invert emulsion based fluid that may include a non-oleaginous internal phase and an oleaginous external phase. The oleaginous fluid used for formulating oil-based fluids and/or invert emulsion fluids used in the practice of the present disclosure are liquids and are more preferably a natural or synthetic oil and more preferably, the oleaginous fluid is selected from the group including diesel oil, mineral oil, synthetic oils such as ester based synthetic oils, polyolefin based synthetic oils (i.e., saturated and unsaturated polyalpha olefin, saturated and unsaturated long chain internal olefins), polydiorganosiloxanes, siloxanes or organo-siloxanes, and mixtures thereof and similar compounds that should be known to one of skill in the art. One of ordinary skill in the art would appreciate that depending on the base fluid selected, it may be desirable to modify the dispersant coated weighting agents described above in accordance with the desired application. For example, modifications may include the hydrophilic/hydrophobic nature of the dispersant.

For invert emulsions, the concentration of the oleaginous fluid should be sufficient so that an invert emulsion forms and may be less than about 99% by volume of the invert emulsion. However, generally the amount of oleaginous fluid must be sufficient to form a stable emulsion when utilized as the continuous phase. In various embodiments, the amount of oleaginous fluid at least about 30 percent, preferably at least about 40 percent, and more preferably at least about 50 percent by volume of the total fluid. In one embodiment, the amount of oleaginous fluid is from about 30 to about 95 percent by volume and more preferably from about 40 to about 90 percent by volume of the invert emulsion fluid. The oleaginous fluid, in one embodiment, may include at least 5 percent by volume of a material selected from the group including esters, ethers, acetals, dialkylcarbonates, hydrocarbons, and combinations thereof.

The non-oleaginous fluid used in the formulation of the invert emulsion fluid disclosed herein is a liquid and may be an aqueous liquid. In one embodiment, the non-oleaginous liquid may be selected from the group including sea water, a brine containing organic and/or inorganic dissolved salts, liquids containing water-miscible organic compounds and combinations thereof. The amount of the non-oleaginous fluid is typically less than the theoretical limit needed for forming an invert emulsion. Thus, in one embodiment, the amount of non-oleaginous fluid is less that about 70 percent by volume and preferably from about 1 percent to about 70 percent by volume. In another embodiment, the non-oleaginous fluid is preferably from about 5 percent to about 60 percent by volume of the invert emulsion fluid.

In an alternative embodiment, water-based wellbore fluids may have an aqueous fluid as the base liquid and the weighting agents of the present disclosure dispersed therein. The aqueous fluid may include at least one of fresh water, sea water, brine, mixtures of water and water-soluble organic compounds and mixtures thereof. For example, the aqueous fluid may be formulated with mixtures of desired salts in fresh water, Such salts may include, but are not limited to alkali metal chlorides, hydroxides, or carboxylates, for example. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, silicon, and lithium, and salts of chlorides, bromides, carbonates, iodides, chlorates, bromates, formates, sulfates, phosphates, nitrates, oxides, and fluorides. Salts that may be incorporated in a brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the drilling fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

Other additives that may be included in the wellbore fluids disclosed herein include for example, wetting agents, organophilic clays, viscosifiers, fluid loss control agents, surfactants, dispersants, interfacial tension reducers, pH buffers, mutual solvents, thinners, thinning agents and cleaning agents. The addition of such agents should be well known to one of ordinary skill in the art of formulating drilling fluids and muds.

Conventional methods may be used to prepare the drilling fluids disclosed herein in a manner analogous to those normally used, to prepare conventional water- and oil-based drilling fluids. In one embodiment, a desired quantity of water-based fluid and suitable amounts of weighting agents are mixed together and the remaining components of the drilling fluid added sequentially with continuous mixing. In another embodiment, a desired quantity of oleaginous fluid, such as a base oil, a non-oleaginous fluid, and suitable amounts of weighting agents are mixed together and the remaining components are added sequentially with continuous mixing. An invert emulsion may be formed by vigorously agitating, mixing or shearing the oleaginous fluid and the non-oleaginous fluid.

### EXAMPLES

The following examples were used to test the effectiveness of the use of the combination of weighting agents disclosed herein on fluid properties.

In the following examples, various additives are used including: SUREMUL® an amidoamine surfactant, SUREWET®, a wetting agent, VG SUPREME™, an organophilic clay, EMI-783, an organophilic clay, VERSATROL™ HT, an HTHP filtration control additive, EMI-663, an HTHP filtration control additive, are all available from M-I, LLC (Houston, Tex.). Bentone 990, an organophilic clay, is available from Elementis Specialties Inc. (Hightston, N.J.). The weighting agents tested in the various samples include an API-grade barite (d₉₀=70−73, d₅₀=20−27), an ultrafine barite (d₉₀=32−36, d₅₀=11−14), a Mn₃O₄ dust (d₉₀≈2.19, d₅₀≈1.01), a dispersant coated micronized barite (d₉₀≈3.0, d₅₀≈1.0), and a micronized dolomite (d₅₀≈2.5).

### Example 1

Referring to Table 1 below, the formulations of various wellbore fluids are shown. Product concentrations are given in pounds per barrel (=grams per 350.5 mL). These fluids were formulated with DF-1 Base Oil at an oil/water ratio of 85:15 by volume. The water phase salinity was 215 g chloride per litre water.

TABLE 1

| | Sample | | | | | | | |
|---|---|---|---|---|---|---|---|---|
| | 1 | 2 | 3 | 4 | 5 | 6 | 7 | 8 |
| DF-1 | 118.0 | 120.0 | 111.0 | 106.6 | 118.6 | 120.0 | 118.2 | 1 |
| Freshwater | 12.3 | 12.5 | 12.4 | 12.0 | 13.1 | 13.2 | 12.3 | 12.8 |
| CaCl₂ liquor | 30.0 | 30.5 | 26.9 | 26.0 | 28.5 | 28.7 | 29.9 | 28.7 |
| SUREMUL ® | 20 | 20 | 20 | 20 | 20 | 20 | 20 | 20 |
| SUREWET ® | 5 | 5 | 5 | 5 | 5 | 5 | 5 | 5 |
| VG SUPREME ™ | 2.0 | 2.0 | 2.3 | 2.3 | 2.3 | 2.3 | 2.0 | 2.0 |
| EMI-783 | 2.0 | 2.0 | 2.3 | 2.3 | 2.3 | 2.3 | 2.0 | 2.0 |
| VERSATROL ™ HT | 9.0 | 9.0 | 5.0 | 5.0 | 5.0 | 5.0 | 5.0 | 9.0 |
| EMI-663 | 3.0 | 3.0 | 5.0 | 5.0 | 5.0 | 5.0 | 5.0 | 3.0 |
| Lime | 10.0 | 10.0 | 10.0 | 10.0 | 10.0 | 10.0 | 10.0 | 10.0 |
| API Barite | 432 | — | — | — | — | — | — | — |
| UltraFine Barite | — | 429.1 | 468.0 | 435.0 | 452.6 | 391.9 | 453.7 | 517.0 |
| Mn₃O₄ | 100 | 100 | — | — | 61.0 | 120.0 | 50.0 | — |
| CaMg(CO₃)₂ | — | — | 55.5 | 94.0 | — | — | 10.0 | — |

Volume Ratios of weight material

| | | | | | | | | |
|---|---|---|---|---|---|---|---|---|
| API Barite | 0.831 | — | — | — | — | — | — | — |
| UltraFine Barite | — | 0.827 | 0.843 | 0.747 | 0.893 | 0.787 | 0.882 | 1.000 |
| Mn₃O₄ | 0.169 | 0.173 | — | — | 0.107 | 0.213 | 0.087 | — |
| CaMg(CO₃)₂ | — | — | 0.157 | 0.253 | — | — | 0.031 | — |

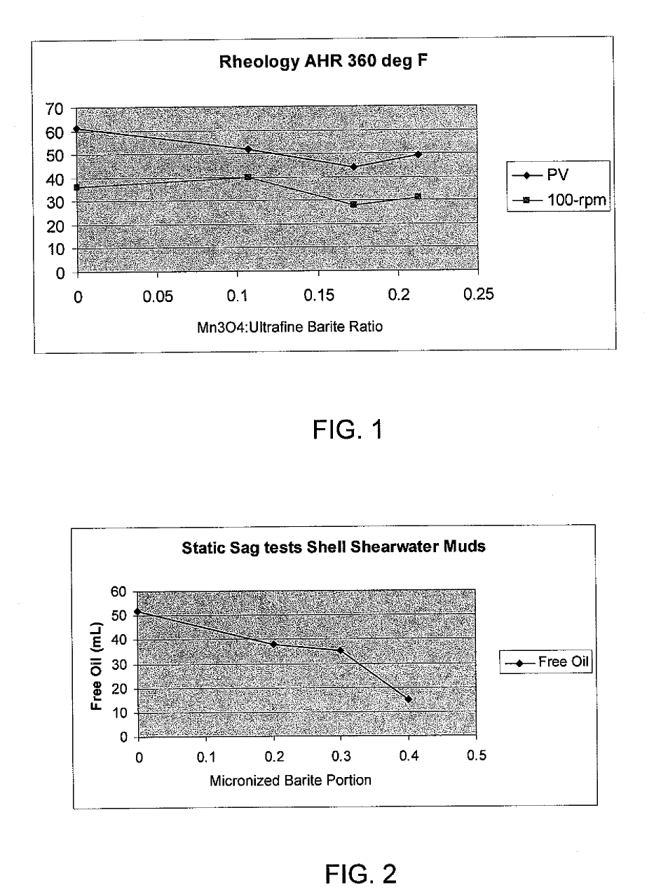

The above fluids were heat rolled at the 360° F. for 16 hours, and the rheological properties of the various mud formations were determined (before and after heat aging) using a Fann 35 Viscometer, available from Fann Instrument Company, per API RP 13B at 120° F. Fluid loss was measured with a saturated API high temperature, high pressure (HTHP) cell, Static sag measurements were obtained from aging the formulated drilling fluid in a static condition at 380° F. for 16 hours. One skilled in the art will realize that this test procedure relates to the behavior of the drilling fluid while static in the well. The measurement records the volume of resulting free oil on top of the column of drilling fluid as well as the density of the top layer of the fluid column and the bottom layer of the fluid column. These densities are used to calculate the static sag factor, where the static sag factor=(botttomSG)/(2*initialSG). The results of which are shown below in Table 2. A summary of some of the data (Samples 2, 5, 6, 8), particularly data showing the effect of the micronized weighting agents on fluid viscosity, is shown in FIG. 1. It is noted that Samples 5 and 6 contain a slightly higher concentration of organoclays (VG-EME™ SUPREME™ and EMI-783) per the formulation data in Table 1, thus likely resulting in a slightly higher plastic viscosity and 100 rpm values.

TABLE 2

| Sample | | | | | | | |
|---|---|---|---|---|---|---|---|
| 1 | 2 | 3 | 4 | 5 | 6 | 7 | 8 |

Before Heat Aging

| | | | | | | | | |
|---|---|---|---|---|---|---|---|---|
| PV (cP) | 62 | 71 | 95 | O/S | 63 | 69 | 71 | 59 |
| YP (lb/100 ft²) | 41 | 45 | 60 | O/S | 39 | 47 | 42 | 39 |
| 100 rpm | 55 | 60 | 80 | 113 | 53 | 61 | 59 | 51 |
| 6 rpm | 20 | 23 | 28 | 39 | 18 | 23 | 20 | 18 |

After Heat Aging

| | | | | | | | | |
|---|---|---|---|---|---|---|---|---|
| PV (cP) | 41 | 44 | 75 | O/S | 52 | 49 | 53 | 61 |
| YP (lb/100 ft²) | 12 | 18 | 40 | O/S | 28 | 21 | 18 | 19 |
| 100 rpm | 26 | 28 | 55 | 77 | 40 | 31 | 30 | 36 |
| 6 rpm | 6 | 7 | 18 | 16 | 13 | 8 | 7 | 8.5 |
| HTHP Fluid loss (mL) | — | — | 3.6 | 3.6 | 2.4 | 4.6 | 4 | 2 |

Static Sag

| | | | | | | | | |
|---|---|---|---|---|---|---|---|---|
| Free Oil | 85 | 55 | 8 | 8 | 50 | 70 | 56 | 55 |
| Sag Factor | 0.610 | 0.549 | 0.517 | 0.507 | 0.524 | 0.587 | 0.569 | 0.557 |

### Example 2

Referring to Table 3 below, the formulations of various wellbore fluids are shown. These fluids were mixed with DF-1 Base Oil at an oil/water ratio of 85:15 and with a water phase salinity of 215 g chloride/litre water. The ratio of Ultrafine barite to Micronized barite was varied as shown. The concentration of other active components is shown as pounds per barrel (=grams per 350.5 mL). The micronized barite is added as a liquid concentrate, but in Table 3, the quantity added has been converted back to base oil and solid barite for ease of comparison.

TABLE 3

| | Sample | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| DF-1 | 126.6 | 127.6 | 78.4 | 64.4 | 65.4 | 64.7 | 66.0 | 70.6 | 70.5 | 0 | 0 | 9.9 | 9.9 |
| Freshwater | 8.6 | 5.1 | 4.8 | 5.0 | 5.1 | 5.1 | 5.2 | 5.1 | 5.1 | 4.4 | 4.4 | 4.8 | 4.8 |
| CaCl₂ liquor | 18.8 | 18.4 | 17.3 | 18.2 | 18.5 | 18.3 | 18.6 | 18.4 | 18.3 | 17.2 | 17.3 | 18.9 | 18.9 |
| SUREMUL ® EH | 20 | 20 | 20 | 20 | 15 | 20 | 15 | 15 | 15 | 16 | 16 | 16 | 16 |
| Bentone 990 | 2 | 2 | 2 | 2 | 2 | 0 | 2 | 2 | 2 | 0 | 0 | 0 | 0 |
| EMI-783 | 3 | 3 | 3 | 3 | 3 | 3 | 3 | 2 | 2.5 | 1 | 0 | 1 | 0 |
| VERSATROL ™ | 6 | 6 | 6 | 6 | 6 | 6 | 6 | 6 | 6 | 6 | 6 | 6 | 6 |
| HT | | | | | | | | | | | | | |
| EMI-663 | 3 | 3 | 3 | 3 | 3 | 3 | 0 | 0 | 0 | 3 | 0 | 0 | 3 |
| Lime | 10 | 10 | 10 | 10 | 10 | 10 | 10 | 10 | 10 | 10 | 10 | 10 | 10 |
| Ultrafine Barite | 571 | 458.4 | 391.3 | 344.3 | 349.6 | 345.5 | 352.5 | 344.2 | 343.9 | 90.3 | 91.2 | 0 | 0 |
| Micronized Barite | — | 119.6 | 192.9 | 234.3 | 234.3 | 234.3 | 234.3 | 236.0 | 236.0 | 491.0 | 491.0 | 554.4 | 554.4 |

Volume Ratios of weight material

| | | | | | | | | | | | | | |
|---|---|---|---|---|---|---|---|---|---|---|---|---|---|
| Ultrafine Barite | 1.000 | 0.800 | 0.700 | 0.600 | 0.600 | 0.600 | 0.600 | 0.600 | 0.600 | 0.158 | 0.158 | 0.000 | 0.000 |
| Micronized Barite | 0.000 | 0.200 | 0.300 | 0.400 | 0.400 | 0.400 | 0.400 | 0.400 | 0.400 | 0.842 | 0.842 | 1.000 | 1.000 |

The fluid rheology, fluid loss, and static sag measurements were taken as described above, with modifications to some test temperatures, as noted below. The results are shown below in Table 4. A summary of some of the data, particularly data showing the showing the effect of the micronized weighting agents on free oil, is shown in FIG. 2.

TABLE 4

| Sample | | | | | | | | | | | | |
|---|---|---|---|---|---|---|---|---|---|---|---|---|
| 1 | 2 | 3 | 4 | 5 | 6 | 7 | 8 | 9 | 10 | 11 | 12 | 13 |

Before Heat Aging

| | | | | | | | | | | | | | |
|---|---|---|---|---|---|---|---|---|---|---|---|---|---|
| 100 rpm | 33 | 36 | 42 | 50 | 50 | 43 | 42 | 28 | 35 | 52 | 39 | 27 | 23 |
| 6 rpm | 10 | 12 | 14 | 17 | 16 | 13 | 13 | 8 | 10 | 16 | 11 | 7 | 5 |

After Heat Aging (350° F.)

| | | | | | | | | | | | | | |
|---|---|---|---|---|---|---|---|---|---|---|---|---|---|
| 100 rpm | 26 | 26 | 30 | 37 | 36 | 34 | 33 | 23 | 28 | 44 | 36 | 34 | 30 |
| 6 rpm | 5 | 5 | 7 | 9 | 8 | 8 | 7 | 5 | 6 | 12 | 10 | 11 | 10 |
| HTHP Fluid | 3.2 | 2.0 | 2.4 | 2.4 | 2.0 | 2.4 | 2.0 | 2.8 | 3.2 | 2.2 | 2.0 | 2.4 | 4.0 |
| loss | | | | | | | | | | | | | |
| (350° F.) | | | | | | | | | | | | | |

Static Sag (375° F.)

| | | | | | | | | | | | | | |
|---|---|---|---|---|---|---|---|---|---|---|---|---|---|
| Free Oil | 52 | 38 | 35 | 15 | 10 | 15 | 12 | 15 | 15 | 5 | 10 | 5 | 12 |
| Sag Factor | 0.570 | 0.556 | 0.509 | 0.527 | 0.535 | 0.548 | 0.532 | 0.585 | 0.543 | 0.521 | 0.544 | 0.535 | 0.552 |

Advantageously, embodiments of the present disclosure for high density wellbore fluids without sacrificing rheology or risk of sag. One characteristic of the fluids used in some embodiments disclosed herein is that the particles form a stable suspension, and do not readily settle out. A farther desirable characteristic of the fluids used in some embodiments disclosed herein is that the suspension exhibits a low viscosity under shear, facilitating pumping and minimizing the generation of high pressures and chances of fluid losses or fluid influxes. Additionally, the fluid slurry may exhibit low filtration rates (fluid loss), and reduced occurrences of gellation under high temperature, high pressure conditions. Further, otherwise costs associated with specialty fluid components may be minimized without sacrificing beneficial performance properties.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A wellbore fluid, comprising:
a base fluid;
a weighting agent having a d₉₀ greater than 30 microns; and
a micronized weighting agent having a d₉₀ less than 25 microns, the micronized weighting agent comprising less than 30 percent by volume of the total weighting agents.

2. The wellbore fluid of claim 1, wherein the micronized weighting agent comprises less than 20 percent by volume of the total weighting agents.

3. The wellbore fluid of claim 2, wherein the micronized weighting agent comprises from about 5 to 20 percent by volume of the total weighting agents.

4. The wellbore fluid of claim 3, wherein the micronized weighting agent comprises from about 10 to 20 percent by volume of the total weighting agents.

5. The wellbore fluid of claim 1, wherein the micronized weighting agent comprises a d₉₀ less than about 10 microns.

6. The wellbore fluid of claim 5, wherein the micronized weighting agent comprises a d₉₀ ranging from about 2 to 8 microns.

7. The wellbore fluid of claim 1, wherein the weighting agent comprises a d₉₀ of at least about 70 microns.

8. The wellbore fluid of claim 1, wherein the weighting agent comprises a d₉₀ of at least about 45 microns.

9. The wellbore fluid of claim 1, wherein the weighting agent comprises at least one of barite, calcium carbonate, dolomite, ilmenite, hematite, olivine, siderite, hausmannite, and strontium sulfate.

10. The wellbore fluid of claim 1, wherein the micronized weighting agent comprises at least one of barite, calcium carbonate, dolomite, ilmenite, hematite, olivine, siderite, hausmannite, and strontium sulfate.

11. The wellbore fluid of claim 1, wherein the wellbore fluid comprises a density of greater than about 15 ppg.

12. The wellbore fluid of claim 13, wherein the wellbore fluid comprises a solids volume fraction ranging from about 35 to 45 percent.

13. The wellbore fluid of claim 1, wherein the micronized weighting agent has a dispersant coating thereon.

14. A wellbore fluid, comprising:
a base fluid;
a weighting agent having a d₅₀ greater than 10 microns; and
a micronized weighting agent having a d₅₀ less than 2 microns, the micronized weighting agent comprising less than 30 percent by volume of the total weighting agents.

15. The wellbore fluid of claim 14, wherein the micronized weighting agent comprises a d₅₀ less than about 1.5 microns.

16. The wellbore fluid of claim 15, wherein the micronized weighting agent comprises a d₅₀ ranging from about 0.8 to 1.2 microns.

17. The wellbore fluid of claim 14, wherein the weighting agent comprises a d₅₀ of at least about 20 microns.

18. The wellbore fluid of claim 14, wherein the micronized weighting agent comprises a d₉₀ ranging from 2 to 8 microns

19. The wellbore fluid of claim 14, wherein the weighting agent comprises a d₉₀ ranging from 30 to 80 microns.

20. The wellbore fluid of claim 14, wherein the wellbore fluid comprises a density of greater than about 15 ppg.

21. The wellbore fluid of claim 14, wherein the micronized weighting agent has a dispersant coating thereon.

22. A wellbore fluid, comprising:
an oleaginous fluid as a continuous phase;
a non-oleaginous fluid as a discontinuous phase;
a weighting agent having a d₉₀ greater than 30 microns; and
a micronized weighting agent having a d₉₀ less than 5 microns, the micronized weighting agent comprising less than 30 percent by volume of the total weighting agents;
wherein the wellbore fluid comprises a solids volume fraction of less than 50 percent.

23. The wellbore fluid of claim 22, wherein the micronized weighting agent has a dispersant coating thereon.

24. A method of increasing the density of a fluid phase of a drilling fluid, the method comprising:
adding to the fluid phase of the drilling fluid at least two weighting agents for increasing the density of the drilling fluid, wherein the at least two weighting agents comprise:
a weighting agent having a d₉₀ greater than 30 microns; and
a micronized weighting agent having a d₉₀ less than 5 microns, the micronized weighting agent comprising less than 30 percent by volume of the total weighting agents.

25. A method of drilling a subterranean well comprising:
adding at least two weighting agents to a base fluid to form a drilling fluid, the at least two weighting agents comprising:
a weighting agent having a d₉₀ greater than 30 microns; and
a micronized weighting agent having a d₉₀ less than 5 microns, the micronized weighting agent comprising less than 30 percent by volume of the total weighting agents; and
drilling the well using the drilling fluid.
